(19) United States
(12) Patent Application Publication
(10) Pub. No.: US 2016/0277532 A1
(43) Pub. Date: Sep. 22, 2016

(54) METHOD AND SYSTEM FOR SELECTING THINGS BASED ON QUALITY OF SERVICE IN WEB OF THINGS

(71) Applicant: ELECTRONICS AND TELECOMMUNICATIONS RESEARCH INSTITUTE, Daejeon (KR)

(72) Inventors: Yong Joon LEE, Daejeon (KR); Mal Hee KIM, Daejeon (KR)

(21) Appl. No.: 14/936,992

(22) Filed: Nov. 10, 2015

(30) Foreign Application Priority Data
Mar. 20, 2015 (KR) 10-2015-0038950

(51) Int. Cl. H04L 29/08; G06N 5/02

(52) U.S. Cl. CPC H04L 67/322; H04L 67/02; G06N 5/025

(57) ABSTRACT

A method and system for recommending a thing based on quality of service in a web of things environment, the method including (a) obtaining web log data and metadata of at least one thing; (b) computing QoS (Quality of Service) features of the thing from the web log data and metadata; (c) in response to obtaining user's review information on the thing, computing QoS grade information on the thing from the review information; and (d) generating a rule for predicting a QoS grade for a thing for which there is no user's review information with reference to the QoS grade information on the thing and the QoS features of the thing.

### CROSS-REFERENCE TO RELATED APPLICATION

The present application claims priority to Korean patent application number 10-2015-0038950, filed on Mar. 20, 2015, the entire disclosure of which is incorporated herein in its entirety by reference.

### BACKGROUND

1. Field of Invention

Various embodiments of the present invention relate to a method and system for selecting and recommending things based on quality of service in a web of things environment.

2. Description of Related Art

WoT (Web of Things) technology is a technology for realizing an IoT (Internet of Things) by connecting various things (sensor device, service etc.) of the real world and virtual world using web technologies (HTML, URI, HTTP etc.).

Generally, the WoT technology abstracts things into resources according to REST (Representational State Transfer) architecture style, expresses URI (URL) for identifying the resources, resource structures, and the resources in various formats (HTML, XML, JSON), and provides a method for connecting in hyperlinks, and REST API based on HTTP methods (POST, GET, PUT, DELETE) for accessing (generating, searching, updating, and deleting) the resources. In such a case, there is an advantage that various things may be easily connected through the web, and the connected things can be combined so as to make a new Mashup service. For example, it is possible to gather data collected from a sensor device (thing) and data collected from a map service (thing) using the REST API, and make a new Mashup service by operating in an interlocked manner with an actuator (thing).

In order to develop or utilize a Mashup service, there needs to be a search function for things, and the user may usually search a desired thing using a keyword.

However, the conventional technology of searching things based on keywords merely provides a list of things that the user wants, and not a search function that takes into consideration the QoS (Quality of Service).

In such a case, for example, when there is a patient of emergency, it is possible to make a search for an AED (Automated External Defibrillator) and emergency room (service) for emergency treatment, but it is not possible to know whether the AED is a normal operating AED or whether or not the emergency room is available to promptly process a request for emergency service. Therefore, a QoS based search for things in WoT is very important.

Recently, for QoS based search for things, a semantic web technology for storing semantic information for expressing/measuring QoS of things in ontology and inferring the QoS through the ontology is being developed. However, not only does the semantic web technology require a lot of effort in constructing the ontology, but it is also difficult to automatically update semantic information of things, making it difficult to actually adopt the technology.

### SUMMARY

Various embodiments of the present invention are directed to resolve all the aforementioned problems of the conventional technology, that is to collect quality information of web services of things and information on users' reviews regarding the web services of things, so as to generate a rule for predicting the QoS grade of the things.

Various embodiments of the present invention are also directed to predict the QoS grade of things according to the generated rule, and to select and recommend things corresponding to high priority QoS grades to the users.

One embodiment of the present invention provides a method for recommending a predetermined thing to a user in a WoT environment, the method including (a) obtaining web log data and metadata of at least one thing; (b) generating QoS features of the thing from the web log data and metadata; (c) in response to obtaining user's review information about thing, computing QoS grade information of the thing from the review information; and (d) generating a rule for predicting a QoS grade for a thing for which there is no review information with reference to the QoS grade information on the thing and the QoS features of the thing.

Another embodiment of the present invention provides a system for recommending proper things to a user in a web of things, the system including a QoS feature generator configured to obtain web log data and metadata of at least one thing, and to compute QoS features of the thing from the web log data and metadata; a QoS classifier generator configured to generate a QoS grade classifier for obtaining user's review information about thing, for computing QoS grade information of thing from the review information, and for predicting a QoS grade of thing which there is no user's review information with reference to the QoS grade information and the QoS features of the thing; and a thing recommender configured to, in response to receiving a request to provide a web of things service from a user, search a list of things and compute QoS features for each of the things, input the QoS features of each of the things to the rule to predict a QoS grade for each of the things, and recommend a thing having a high QoS grade to the user.

According to the aforementioned embodiments of the present disclosure, it is possible to collect quality information of web service of things and user's review information about web service of things, and generate a rule for predicting the QoS grade of things.

Furthermore, according to the aforementioned embodiments of the present disclosure, it is possible to predict the QoS grade of things according to the generated rule, and select and recommend things corresponding to high priority QoS grades to the users.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a view schematically illustrating an entirety of a system for recommending things to users based on QoS in a web of things environment;

FIG. 2 is a view illustrating in detail an internal configuration of a system for providing a web of things service according to an embodiment of the present disclosure;

FIG. 3 is an exemplary view for explaining QoS features being computed according to an embodiment of the present disclosure;

FIG. 4 is an exemplary view for explaining resource request/response data being obtained from web log data according to an embodiment of the present disclosure;

FIG. 5 is an exemplary view for explaining a process of a QoS grade classifier being generated according to an embodiment of the present disclosure; and

FIGS. 6 to 8 are conceptual views for explaining an entirety of process where a thing is recommended to a user according to an embodiment of the present disclosure.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected or accessed to another component or indirectly connected or accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

[Embodiment of the Present Disclosure]

Configuration of an Entirety of the System

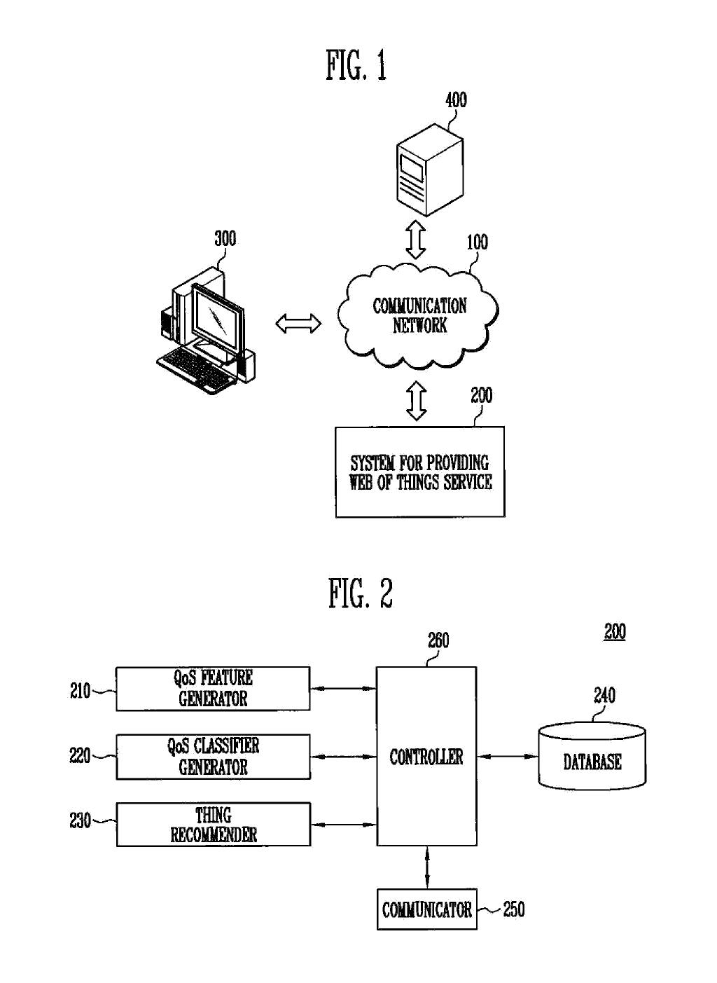

FIG. 1 is a view schematically illustrating an entirety of a system for recommending things to users based on quality of service (hereinafter referred to as QoS) in a web of things environment.

As illustrated in FIG. 1, the entirety of the system according to an embodiment of the present disclosure may include a communication network 100, system for providing web of things service 200, user terminal apparatus 300, and server 400.

First of all, the communication network 100 according to the embodiment of the present disclosure may have a two-aspect configuration of wired and wireless communication, and furthermore, the communication network 100 may be configured as one of various types of communication networks including WAN (Wide Area Network), LAN (Local Area Network), mobile communication network, and mobile communication network, and satellite communication network. More specifically, the communication network 100 in the present disclosure may include a wireless communication network realized by technologies of IEEE 802.11, CDMA (Code Division Multiple Access), WCDMA (Wideband Code Division Multiple Access), GSM (Global System for Mobile communications), and LTE (Long Term Evolution). However, the communication network 100 may include in at least some part thereof a well known wired/wireless data communication network, well known telephone network or well known wired/wireless television communication network.

Next, a system for providing a web of things service 200 according to an embodiment of the present disclosure may collect QoS features of things (not illustrated) and users' review information on each of the things, and perform a function of generating a rule for predicting a QoS grade of the things based on the collected QoS features and users' review information on the things. Furthermore, at a service request by the user, the system for providing a web of things service 200 may search for serviceable things, predict a QoS grade for each of the things according the generated rule, and recommend things corresponding to high priority QoS grades to the user.

Explanation on the configuration and functions of the system for providing a web of things service 200 according to the present disclosure will be made in detail later on.

Next, a user terminal apparatus according to an embodiment of the present disclosure 300 is a digital apparatus that includes a function of connecting to a system for providing a web of things service 200 or a server 400 and communicating with the same. Any digital apparatus such as a desktop computer, notebook computer, workstation, PDA, web pad, mobile phone and the like that are provided with a memory means and microprocessor so as to provide computation capabilities may be selected as a user terminal apparatus 300 according to the present disclosure. Especially, the user terminal apparatus 300 may include a browser (not illustrated) program that enables a user to receive a web of things service.

Lastly, the server 400 according to an embodiment of the present disclosure may be an information provision apparatus capable of communicating with the system for providing a web of things service 200 or the user terminal apparatus 300. Such a server 400 may be, for example, one of various types of web servers, and especially, one that may directly provide web log data or information related to web log data to the system for providing a web of things service 300.

Furthermore, the server 400 may connect an IP-based sensor network consisting of things of heterogeneous networks with the conventional Internet (for example, IP network), so that the things may be connected to the Internet. That is, in response to receiving a request of specifying a thing based on an IP address to perform communication from the user terminal apparatus 300, the server 400 may compress the HTTP, TCP, UDP, and IP header used in performing communication so as to be transmittable to the things (that is, sensor network), and may perform a function of restoring the compression on a response from the things so as to be transmittable to the user terminal apparatus 300 on the internet.

Configuration of a System for Providing a Web of Things Service

Hereinafter, explanation will be made on the configuration of the system for providing a web of things service according to the present disclosure 200 and functions of each component thereof.

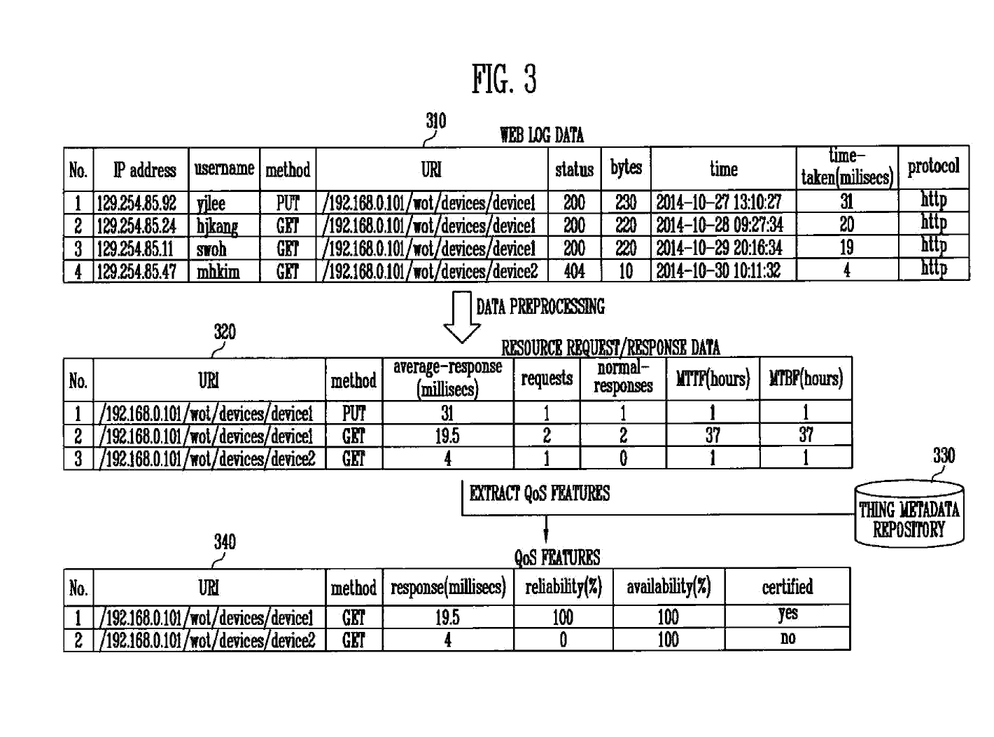

FIG. 2 is a view illustrating in detail the internal configuration of the system for providing a web of things service according to an embodiment of the present disclosure 200.

As illustrated in FIG. 2, the system for providing a web of things service according to the embodiment of the present disclosure may include a QoS feature generator 210, QoS classifier generator 220, thing recommender 230, database 240, communicator 250 and controller 260. According to the embodiment of the present disclosure, at least a portion of the QoS feature generator 210, QoS classifier generator 220, thing recommender 230, database 240, communicator 250 and controller 260 may be a program module that communicates with the user terminal apparatus 300 or the server 400. Such a program module may be included in the system for providing a web of things service 200 in the format of an application program module or other program module, and physically, the program module may be stored in various types of well known memory devices. Furthermore, such a program module may be stored in a remote memory device that is capable of communicating with the system for providing a web of things service 200. Meanwhile, such a program module may include a routine, sub routine, program, object, component, and data structure configured to perform a certain task or to perform a certain abstract data type that will be explained hereinafter, but without limitation.

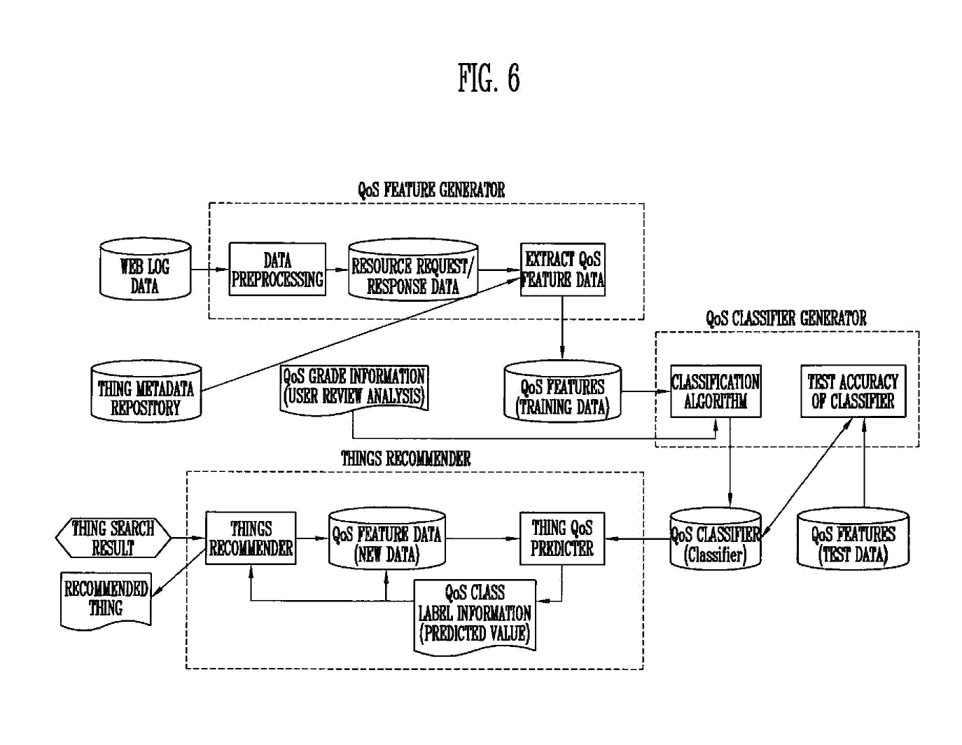

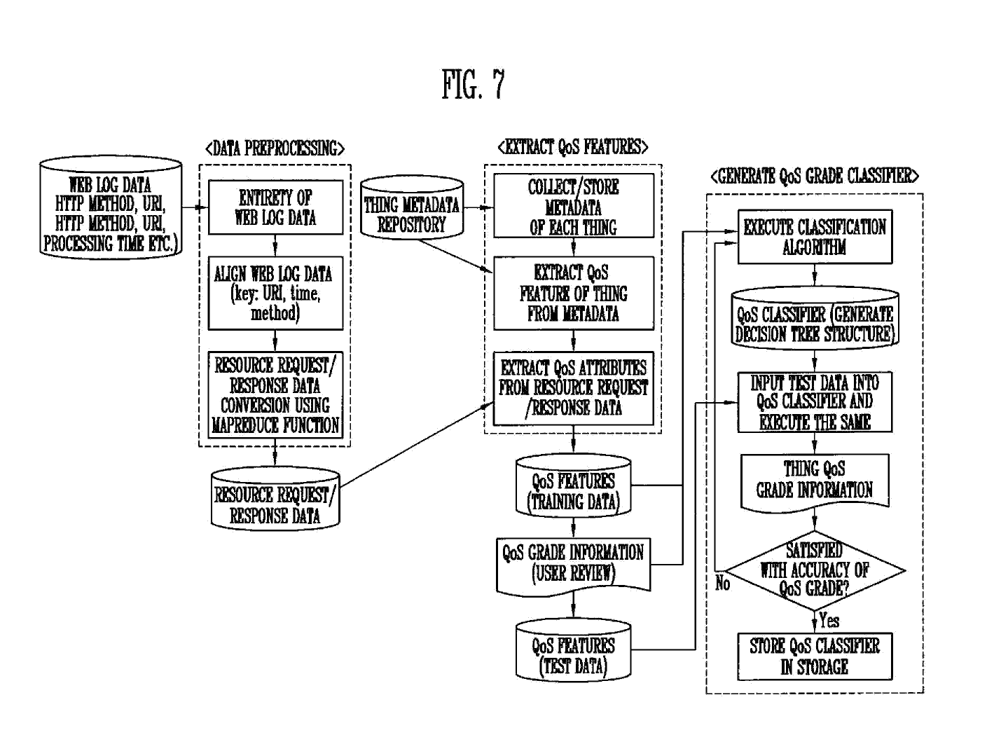

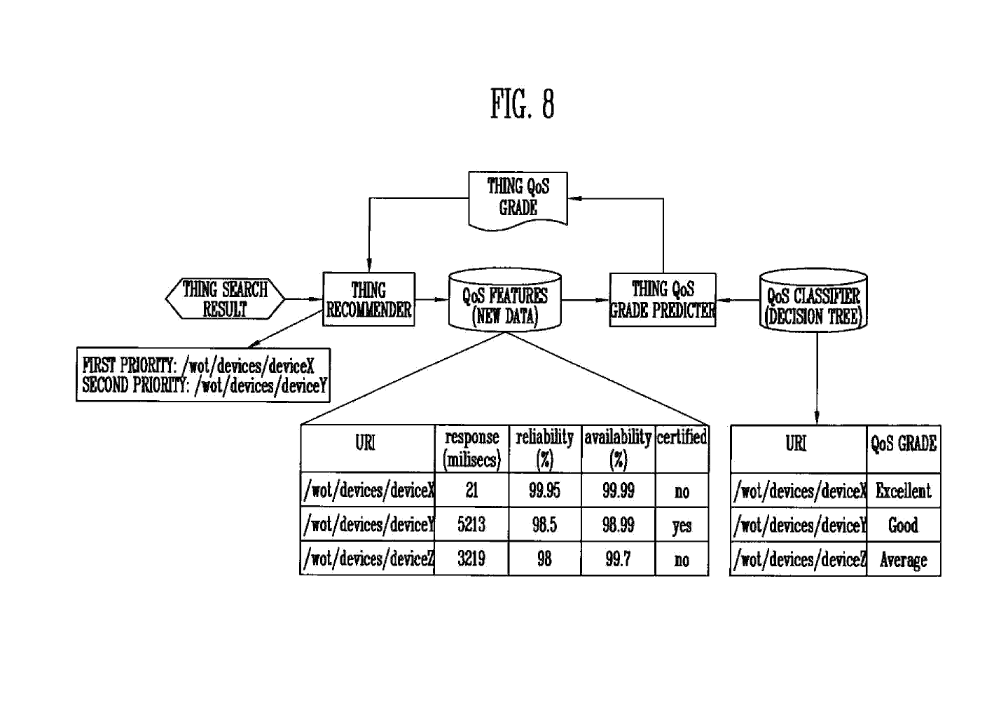

FIGS. 6 to 8 are conceptual views for explaining an entirety of process where a thing is recommended to a user according to an embodiment of the present disclosure. Hereinafter, explanation will be made on the specific functions of the QoS feature generator 210, QoS classifier generator 220, and thing recommender 230 with reference to FIGS. 6 to 7.

First of all, the QoS feature generator 210 according to the embodiment of the present disclosure may perform a function of computing web log data, that is a record of processing a request for a web of things service, and computing QoS feature from the metadata of things.

Web log data is data that has been processed and recorded at a request for a web of things service. The web log data may include an IP address that sent the request, processing time, HTTP method processing information and the like. Furthermore, thing metadata is information on a thing, that may include an ID, name, explanation, manufacturer, manufactured data, photograph, and certification information of the thing. The thing metadata may be registered by the developer of the thing.

In response to obtaining web log data regarding a thing, the QoS feature generator 210 may refine the web log data and convert the same into a request/response data through a data preconditioning process, and more specifically, the QoS feature generator 210 may perform a data preconditioning process on the web log data so that the converted resource request/response data includes an average response time, and number of times of requests/responses, that are statistical data of request/response records of the thing.

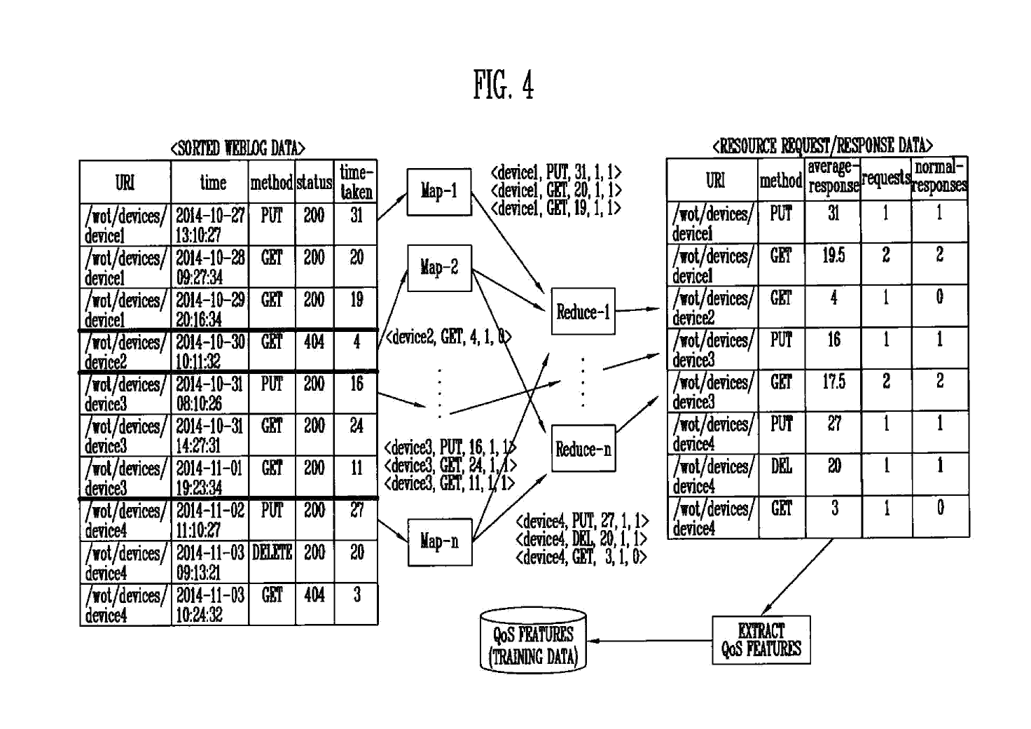

The QoS feature generator 210 may generate QoS feature from the resource request/response data and metadata of the thing. Especially, the QoS feature data generated by the QoS feature generator 210 may include information on an average time of response to a request for a web of things service, information on the reliability that is, the number of times of normal responses at requests made for a web of things service during a predetermined period of time, information on the availability, that is the ratio of time that the web of things service is not turned down during a predetermined period of time, and information on whether or not a certification has been made. Hereinafter, QoS feature on a thing being computed according to an embodiment of the present disclosure will be explained in detail with reference to FIG. 3.

FIG. 3 is an exemplary view for explaining QoS feature being computed according to an embodiment of the present disclosure.

First of all, the QoS feature generator 210 may obtain the web log data and then perform a function of refining the data that is unnecessary or data that includes errors. As illustrated in FIG. 3, the refined web log data 310 may have a record consisting of <IP address, username, method, URI, status, bytes, time, time-taken, protocol> feature. Meanwhile, an ‘IP address’ refers to the IP address that requested the service, ‘user name’ refers to the name of the user who requested the service, ‘method’ refers to the name of the HTTP request method, ‘URI’ refers to the URI of the resource requested, ‘status’ refers to the state code of a response result, ‘bytes’ refers to the amount of data transmitted during a request/response, ‘time’ refers to the time point where a response has been completed, ‘time-taken’ refers to the response time, and ‘protocol’ refers to the protocol used for the request/response.

For example, <129.254.85.92, yjlee, PUT, /192.168.0.101/wot/devices/device1, 200, 230, 2014-10-27 13:10:27, 31, http> record may mean that a user named ‘yjlee’ who uses an IP address of 129.254.82.92 made a PUT request to device1, and a normal response (status 200) was made at 13th hour, 10 minutes, 27 seconds on Oct. 27, 2014, and 230 bytes of data was transmitted, and the response time was 31 millisecs.

Meanwhile, the web log data 310 may be sorted in the key order of <URI, time, method>, and the QoS feature generator 210 may convert the sorted web log data into resource request/response data 320 using a MapReduce function.

The method of converting the sorted web log data 310 into resource request/response data 320 using the MapReduce function will be explained in more detail with reference to FIG. 4 later on.

As illustrated in FIG. 3, the response request/response data 320 is statistical data of a request/response regarding each of a plurality of things (resources), and the response request/response data 320 may include a record consisting of <URI, method, average-response, requests, normal responses, MTBF, MTTF> features. First of all, ‘Average-response’ refers to an average value of the ‘time-taken’ feature of the web log data, ‘requests’ refers to the total number of requests regarding a thing (resource), and the ‘normal responses’ refers to the total number of normal responses. Furthermore, MTTF (Mean Time To Failure) refers to the time from restoration until the next breakdown, that is the normal operating time, and MTBF (Mean Time Between Failure) refers to the time from a breakdown until the next breakdown, that is, the interval of the average breakdown time.

For example, </device1, GET, 19.5, 2, 2, 37, 37> may mean that the average response time of a GET request regarding device1 is 19.5 millisecs, the total number of requests is 2, the total number of normal responses is 2, and MTTF is 37 hours. Numerical values representing MTTF and MTBF may be calculated by analyzing the ‘time’ feature of the web log data. For example, since the time interval that device1 made a normal response is 37 hours, MTTF may be 37, and since there was no breakdown, MTBF may be 37.

Meanwhile, the QoS feature generator 210 may collect metadata of each of a plurality of things connected via the web inside the web of things environment, and store the collected metadata in a predetermined metadata repository 330, and in a case of intending to obtain QoS feature of a certain thing, the QoS feature generator 210 may obtain metadata corresponding to the certain thing from the metadata repository 330.

More specifically, the QoS feature generator 210 may obtain certification information, that is a feature to be used as QoS feature of among the features (ID, title, name, manufacturer, manufactured data, photo, certification information of the thing) of the metadata stored in the metadata repository 330. Meanwhile, in the present specification, for the sake of ease of explanation, explanation was made based on an assumption that an additional metadata repository 330 is provided as a repository for storing the metadata of things, but without limitation. Thus, the metadata of things may be stored in a repository that is physically differentiated as aforementioned, or may be stored in a database of the system for providing a web of things service according to the present disclosure.

As illustrated in FIG. 3, the QoS feature generator 210 may generate QoS feature 340 regarding a thing from the metadata and response request/response data 320. It is possible to obtain information on the ‘method’, ‘response’, ‘reliability’ and ‘availability’ features from the resource request/response data 320, and obtain information on the ‘certification information’ from the metadata.

Of among the attributes representing QoS features, the ‘response’ attribute is the response time, that is the time it, takes to be provided with a response to a service request, and the ‘reliability’ attribute is the reliability, that is the extent of preciseness of normality to the service request during a given period of time, and the ‘availability’ attribute is the availability representing the ratio of time where service is not turned down during the given period of time.

The QoS feature generator 210 may obtain data value regarding the ‘average-response’ attribute of among the resource request/response data 320 as the data value regarding the ‘response’ attribute, and the ‘reliability’ attribute and ‘availability’ attribute may each be computed by math formula 1 and math formula 2.

$$\begin{matrix}\frac{normal - responses}{requests} \times 100 & Math formula 1 \\ \frac{MTTF}{MTBF} \times 100 & Math formula 2\end{matrix}$$

That is, as illustrated in FIG. 3, QoS feature 340 having a record consisting of <URI, method, response, reliability, availability, certified> features may be generated. Hereinafter, a process of obtaining resource request/response data from the web log data according to the embodiment of the present disclosure will be made with reference to FIG. 4.

FIG. 4 is a view for explaining an example of resource request/response data being obtained from the web log data according to the embodiment of the present disclosure.

The sorted web log data according to the embodiment of the present disclosure is converted into resource request/response data through dispersed processing using a MapReduce function. The MapReduce is a core function of Hadoop which is an open source big data platform, which stores the web log data dispersedly through a dispersed file system of an HDFS (Hadoop Distributed File System), and processes (calculates) an operation of converting into the resource request/response data through the MapReduce function.

A Map function receives key(k1) and value(v1) as inputs of function, and uses the received key-values to parallel-process a logic of the user, and then outputs a new list of key(k2) and value(v2). When the Map function is performed repeatedly, numerous pieces of output data will be generated, and that output data will be sorted to the key(k2), and thus numerous values(list(v2)) will exist in each key(k2). A Reduce function receives inputs of key(k2) and value list (list(v2)), parallel-calculates the logic of the user, and then outputs a list of numerous ‘key(k3)-value(v3)’.

More specifically, as illustrated in FIG. 4, the web log data is aligned and stored in the order of <URI, time, method>. In the case of a bulk web log data, the data may be stored dispersedly in numerous nodes using the dispersed file system (for example, Hadoop HDFS), The Map function (Map-1) parallel-processes the web log data and outputs <URI, method, time-taken, request count, response count>, that is temporary data. The input key(k1) regarding the Map function (Map-1) is <URI, time, method>, the input value(v1) is <status, time-taken>, the output key(k2) is <URI, method>, and the output value(list(v2)) is <time-taken, request-count, response-count>. For example, the output result of the Map function regarding device1 of the web log data (Map-1) is <device1, PUT, 31, 1, 1>, <device1, GET, 20, 1, 1>, <device1, GET, 19, 1, 1>, that is, temporary data. The Reduce function (Reduce-1) aggregates the temporary data, and outputs resource request/response data, <URI, method, average-response, requests, normal-responses>. The input key(k2) regarding the Reduce function (Reduce-1) is <URI, method>, the input value(list(v2)) is <time-taken, request-count, response-count>, the output key(k3) is <URI, method>, and the output value(v3) is <average-response, requests, normal-responses>. For example, the output result of the Reduce function regarding device1 of the web log data (Reduce-1) is resource request/response data, <device1, PUT, 31, 1, 1>, <device1, GET, 19.5, 2, 2>. The average-response(1) of device1 and the average-response(19.5) of device2 may be computed by calculating the average value and standard deviation of the time-taken feature while executing the Reduce function.

According to the present disclosure, as a dispersed processing method is performed using an open source, Hadoop MapReduce, in order to efficiently extract the QoS feature of things from the bulk web log data (big data), it is possible to generate the QoS feature efficiently and inexpensively.

Next, the QoS classifier generator 220 according to an embodiment of the present disclosure may perform a function of generating a rule that enables prediction of a QoS grade of things based on QoS features of things obtained from the QoS feature generator 210 and users' review information about things.

First, the QoS classifier generator 220 may collect review information on a thing from a plurality of users who use a web of things service, and then statistically analyze the collected review information of the users so as to compute a QoS grade for the thing. For example, assuming that user's review information on a thing is expressed as one of excellent, good, average, and poor, when 1000 users gave excellent, 100 users gave good, and 30 users gave poor for a certain thing (device 1), the QoS grade of device 1 computed by calculating an average value of the review information and standard deviation may be excellent.

According to an embodiment of the present disclosure, the QoS classifier generator 220 may generate a QoS classifier that predicts a QoS grade of a thing for which there is no user's review information through machine learning having QoS features and QoS grade information for each thing as training data.

More specifically, the QoS classifier generator 220 may generate a classifier that may execute a classification algorithm based on QoS features and QoS grade information and learn a rule for QoS grade evaluation, and classify input data (QoS features in the present disclosure) where the rule has been applied per grade. The classification algorithm may be a decision tree algorithm such as ID3, C4.5, CART, and CHAID.

That is, according to the present disclosure, the QoS grade classifier may be a decision tree generated based on QoS features and QoS grade information, and more particularly, when the QoS feature variable is defined as ‘features’, and the QoS grade information is defined as ‘labels’, it may be expressed as mapping function ‘f’ as shown below, and it is possible to perform a classification algorithm and generate function f.

Mapping function: f(features)→labels

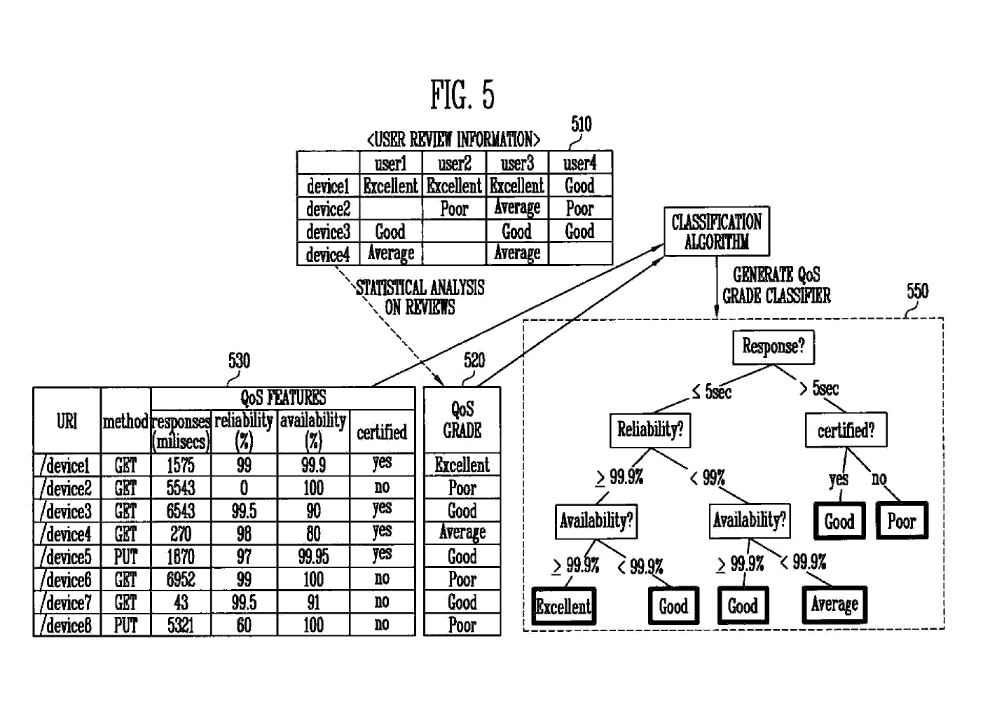

More specifically, it is possible to it is possible to pre-classify ‘labels’ into excellent, good, average, and poor; extract ‘response’, ‘reliability’, ‘availability’, and ‘certified’ as features for classifying the ‘labels’, and then generate a classifier (or, classification rule) from the QoS features and QoS grade (QoS grade may have the same meaning as the label in the map function). Hereinafter, a process of generating a QoS grade classifier according to an embodiment of the present disclosure will be explained in detail with reference to FIG. 5.

FIG. 5 is an exemplary view for explaining a QoS grade classifier being generated according to an embodiment of the present disclosure.

First of all, the QoS classifier generator 220 may collect user's review information 510 for each of a plurality of things, analyze the information 510 statistically, and compute a QoS grade 520 for each of the plurality of things. For example, as illustrated in FIG. 5, it is possible to calculate a review average and standard deviation of the review information 510 for devices 1, 2, 3, and 4, and generate QoS grade information 520, and QoS grade information for device 1 may be excellent, QoS grade information for device 2 may be poor, QoS grade information for device 3 may be good, and QoS grade information for device 4 may be average. Meanwhile, in the present disclosure, it is explained that the QoS grades are excellent, good, average, and poor for the sake of convenience in explanation, but there is no limitation thereto.

The QoS classifier generator 220 may receive input of QoS features 530 and QoS grade information 520 as training data, and generate a QoS grade classifier through a classification algorithm. Meanwhile, as aforementioned, the classification algorithm may be a decision tree algorithm such as ID3, C4.5, CART, and CHAID.

As illustrated in FIG. 5, the QoS grade classifier generated by receiving the QoS features and QoS grade information of devices 1 to 8 may be expressed in a decision tree 550 that is a collection of classification rules.

The decision tree 550 may include a root node, intermediate node, and leaf node, and further, the decision tree 550 may include a branch that connects the nodes.

The leaf node of the QoS grade classifier (decision tree) 550 of the present disclosure may be a QoS label, and the root node and intermediate node may be QoS features. The QoS features 530 may be normalized in order to easily configure a decision tree. For example, ‘response’ (1575 milliseconds) of device 1 may be converted into a normalized ‘response’ feature value (<5 sec).

Meanwhile, to express a decision tree 550 of the QoS grade classifier in a rule, the rule may be as follows: Rule 1 is “IF (response >5 sec) AND certified=‘no’ THEN QoS=‘Poor’”, Rule 2 is “IF (response ≦5 sec) AND reliability ≧99% AND availability ≧99.9% THEN QoS=‘Excellent’”, Rule 3 is “IF (response ≦5 see) AND reliability <99% AND availability ≧99.9% THEN QoS=‘Good’”, and Rule 4 is “IF (response ≦5 sec) AND reliability ≧99% AND availability <99.9% THEN QoS=‘Average’”.

As illustrated in FIG. 7, the QoS classifier generator 220 according to an embodiment of the present disclosure may perform a test for measuring the accuracy of the QoS grade classifier generated. More specifically, it is possible to collect QoS features as the test data for measuring the accuracy of the QoS grade classifier, and especially, the QoS features being used as the test data may not be one used as the training data for generating the QoS classifier generator. The QoS classifier generator 220 may input QoS features that is the test data into the QoS grade classifier, and compare and analyze whether or not the computed QoS label information is accurate, thereby determining the accuracy of the QoS grade classifier. For example, it is possible to compare with the QoS grade information computed from the review information regarding the thing corresponding to the QoS features used as the test data and determine the accuracy of the QoS grade classifier.

As illustrated in FIG. 7, the QoS classifier generator 220 may store the QoS grade information in a predetermined storage if the QoS grade information is accurate, and if it is determined that the QoS grade information is not accurate, the QoS classifier generator 220 may receive input of another QoS features and QoS grade information as training data and regenerate the QoS grade classifier.

According to the present disclosure, the greater the training data, the more accurate the QoS grade classifier, and every time training data is newly input and a QoS grade classifier is regenerated, the condition indicating the rule may differ.

Next, in response to there being a request for a web of things service from the user, the thing recommender 230 according to an embodiment of the present disclosure may search for serviceable things, and may perform a function of recommending a thing having the highest QoS grade of among the searched things to the user.

In response to there being a thing for which there is no QoS grade information of among the searched things, the thing recommender 230 may predict a QoS grade for each of the things for which there is no QoS grade information using the QoS grade classifier generated from the QoS classifier generator 220. More specifically, it is possible to input QoS features for each of the things for which there is no QoS grade information in the QoS grade classifier, thereby predicting the QoS grade. Then, the thing recommender 230 may compare the QoS grades of the searched things and recommend a thing with a high grade to the user.

More specifically, as illustrated in FIG. 6, a result of search for a thing may be input into the thing recommender, and the thing recommender may transmit QoS features of the things for which there is no QoS grade information to a thing QoS predictor. The thing QoS predictor may execute the QoS grade classifier and predict the QoS label information of each of the things, and then transmit the predicted QoS label information to the thing recommender, thereby providing information on the recommended thing to the user.

For example, as illustrated in FIG. 8, the thing recommender may obtain the QoS features of a thing list (deviceX, deviceY, deviceZ) included in the result of search for a thing from the QoS features generator 210, and transmit the obtained QoS features to the thing QoS predictor. Next, the thing QoS predictor inputs QoS features into the QoS grade classifier, and sends QoS label information of each of the things (deviceX, deviceY, deviceZ) obtained from the QoS grade classifier to the thing recommender. The thing recommender may select things having high QoS grades from among the things, that is device X and device Y as recommended things, and provide information on the things having high QoS grades to the user.

Meanwhile, FIGS. 6 to 8 illustrate that a web log data, resource request/response data, thing metadata, QoS features, and QoS grade classifier are each stored in a separate storage, but there is no limitation thereto. Thus, the web log data, resource request/response data, thing metadata, QoS features, and QoS grade classifier may be stored altogether in one storage (for example, database of a system for providing a web of things service according to the present disclosure).

Since the present disclosure automatically generates a classifier (rule) for predicting a QoS grade of a thing using the classification technology of machine learning, it is possible to update/expand a rule with less efforts than in the conventional technology of expressing and inferring the QoS of things. More specifically, since the semantic web technology stores and manages semantic information for expressing/measuring and inferring (predicting) QoS in ontology, a lot of effort must be put into establishing the ontology, and it is difficult to automatically update the ontology. On the other hand, in the case of the present disclosure, since it is possible to automatically generate a classifier (rule) for predicting a QoS grade, it is easy to update the rule. Especially, the present disclosure uses QoS features and QoS grade information of things as training data necessary for increasing the accuracy of the QoS grade classifier, but uses web log data where history of request/response for things is accurately recorded to extract QoS features, and computes QoS grade information from the review information, thereby generating a QoS grade classifier having a high accuracy, the more abundant the training data, the longer the accuracy of the classifier may be increased.

Furthermore, unlike the conventional method of analyzing user profiles and classifying into user groups with similar features, and using the same to predict and recommend preference of the users, the present disclosure does not need user profiles, and thus it is possible to protect users' privacy and recommend appropriate things.

Next, in the database 240 according to an embodiment of the present disclosure, QoS features, metadata of things, and QoS grade classifier may be stored. Although FIG. 2 illustrates that the database 240 is included in the system for providing a web of things service 200, depending on those skilled in the art, the database 240 may be configured separately from the system for providing a web of things service 200. Meanwhile, the database 240 of the present disclosure is a concept that includes a computer readable record media, and it may be a database in a narrow sense but also a database in a broad sense that includes data records based on a file system, and as long as it may be searched and extracted, any simple collection of logs may be a database 240 of the present invention. Next, the communicator 250 according to an embodiment of the present disclosure may perform a function that enables data transceiving to and from the QoS features generator 210, QoS classifier generator 220, thing recommender 230, and database 240.

Lastly, the controller 260 according to an embodiment of the present disclosure may perform a function of controlling flow of data between the QoS features generator 210, QoS classifier generator 220, thing recommender 230, database 240, and communicator 250. That is, the controller 260 according to the present disclosure may control each of the QoS features generator 210, QoS classifier generator 220, thing recommender 230, database 240 and communicator 250 to perform their unique functions by controlling data flow to and from the system for providing a web of things service 200 and data flow between the components of the system for providing a web of things service 200.

The aforementioned various embodiments of the present disclosure may be realized in program command formats that may be performed through various computer components and be recorded in a computer readable record media. The computer readable record media may include a program command, data file, or data structure, or a combination thereof. A program command being recorded in a computer readable record media may be one that has been especially designated and configured for the present disclosure or one that is well known in the related art. Examples of computer readable record media include magnetic media such as hard disk, floppy disk, and magnetic tape; optic record media such as CD-ROM and DVD; magneto-optical media such as floptical disk; and hardware apparatus especially configured to store and perform program commands such as ROM, RAM, and flash memory and the like. Examples of program commands include not only mechanical codes such as those made by compilers but also sophisticated language codes that may be executed by computers using interpreters. The hardware device may be configured to operate as one or more software modules in order to perform processes of the present disclosure, and vice versa.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method for recommending a predetermined thing to a user in a web of things environment, the method comprising:
(a) obtaining web log data and metadata of at least one thing;
(b) computing QoS (Quality of Service) features of the thing from the web log data and metadata;
(c) in response to obtaining user's review information on the thing, computing QoS grade information on the thing from the review information; and
(d) generating a rule for predicting a QoS grade for a thing for which there is no review information with reference to the QoS grade information on the thing and the QoS features of the thing.

2. The method according to claim 1,
further comprising:
(e) in response to receiving a request to provide a web of things service from a user, searching a list of things, and computing QoS features for each of the things; and
(f) applying the QoS features of each of the things to the rule to predict a QoS grade for each of the things, and recommending a thing having a high QoS grade to the user.

3. The method according to claim 1,
wherein the QoS features is a collection of data regarding i) features indicating a response time to a request for a web of things service, ii) features indicating a reliability of an extent of normal response to the request for a web of things service for a predetermined period of time, iii) features indicating availability of a thing, and iv) features representing authentication information on the thing.

4. The method according to claim 3,
wherein the rule is a decision tree generated based on machine learning having QoS grade information on the thing and QoS features on the thing as training data.

5. The method according to claim 4,
wherein the decision tree comprises a root node, intermediate node, and leaf node, and
the root node and intermediate node are features of the QoS features, and the leaf node is QoS recommendation grade.

6. The method according to claim 4,
further comprising testing an accuracy of the decision tree.

7. The method according to claim 6,
wherein the testing an accuracy of the decision tree involves collecting QoS features and QoS grade information not used as training data as test data, and
comparing whether or not QoS grade information obtained by applying the QoS features to the decision tree is the same as QoS grade information collected as the test data.

8. The method according to claim 7,
wherein, in response to the decision tree being determined as being inaccurate, updating a rule forming the decision tree.

9. The method according to claim 1,
wherein the QoS grade is an average value of review information obtained from a plurality of users regarding the thing.

10. A system for recommending proper things to a user in a web of things environment, the system comprising:
a QoS features generator configured to obtain web log data and metadata of at least one thing, and to compute QoS features of the thing from the web log data and metadata;
a QoS classifier generator configured to generate a QoS grade classifier for obtaining user's review information on the thing, for computing QoS grade information on the thing from the review information, and for predicting a QoS grade for a thing for which there is no review information with reference to the QoS grade information on the thing and the QoS features of the thing; and
a thing recommender configured to, in response to receiving a request to provide a web of things service from a user, search a list of things and compute QoS features for each of the things, input the QoS features of each of the things to the rule to predict a QoS grade for each of the things, and recommend a thing having a high QoS grade to the user.

11. The system according to claim 10,
wherein the web log data is a collection of data regarding at least one of an IP address that requested a web of things service, name of user who requested the web of things service, method name of HTTP request, URI of request resource, amount of data transmitted during the request and response for the web of things service, and features of the response time to the web of things service request time.

12. The system according to claim 11,
wherein the QoS features generator obtains request response and request data from the web log data using a MapReduce function, and computes the QoS features from the resource response and request data.
